(19) United States
(12) Patent Application Publication
(10) Pub. No.: US 2014/0307412 A1
(43) Pub. Date: Oct. 16, 2014

(54) Lighting Device Which Attaches to a Desktop, Laptop or Tablet Computer or Smartphone, Providing Even Illumination of the User's Face.

(71) Applicant: Roberto Prado, Los Angeles, CA (US)

(72) Inventor: Roberto Prado, Los Angeles, CA (US)

(21) Appl. No.: 13/862,375

(22) Filed: Apr. 12, 2013

(51) Int. Cl. G03B 15/03

(52) U.S. Cl. CPC G03B 15/03
USPC 362/3

(57) ABSTRACT

A lighting device which attaches to a desktop, notebook or tablet computer. is claimed. One critical new feature of this invention is that it connects directly to the desired appliance without requiring additional desk or tabletop surface area. Another critical feature of this invention is that it provides even illumination over the entire subject area. Another critical new feature of this invention is that it is portable. Another critical feature of this invention is that it is inexpensive.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

1. Field of the Invention

Under the general field of endeavor which includes electrical illumination, this device can further be classified as a light source with an incorporated mounting means, specifically for use with desktop, laptop, or tablet computer, or with a smartphone.

2. Description of Related Art

Conventional lighting systems are usually built as stand-alone lamps, or as attachments to cameras or clip on lamps intended to illuminate a work area. Video bloggers, news correspondents and people using the computer to record video journals or video conference currently have to use large, expensive photographic lighting devices, or modify existing household lighting devices in order to properly light their face or photo subject. It is not uncommon for users to be dark or barely visible if background light sources are too strong, such as bright sunlight, or too dim, as in the case of a dimly lit room. Use of lighting devices not intended for the purposes outlined above, can result in too much light on the subject, producing a “washed out” effect. Also, professional photographic lamps are large, expensive and difficult to carry from one location to another.

Current lighting systems for computers are designed to illuminate the keyboard or the display in the manner of a desk lamp or a reading lamp; or they are designed to decorate the computer itself. Conventional photographic lighting systems are usually built as stand-alone lamps, or as attachments to cameras.

One critical new feature of this invention is that it connects directly to the desired appliance without requiring additional desk or tabletop surface area. Another critical feature of this invention is that it provides even illumination over the entire subject area. Another critical new feature of this invention is that it is portable. Another critical feature of this invention is that it is inexpensive.

### BRIEF SUMMARY OF THE INVENTION

The primary purpose of the invention is to provide individuals using computing and telecommunications devices equipped with, or with attached, cameras with a lighting system which evenly illuminates the subject of the camera, most commonly their face. This invention was originally conceived for use by war correspondents embedded with troops, or in the field, and only a laptop or tablet device with which to prepare their stories. Lighting systems currently available did not meet the necessary criteria and the device herein claimed was invented as a result.

Further analysis revealed additional application of the device by video-bloggers, independent journalists and consumers using mobile computing devices equipped with cameras for video based telecommunications.

Variations of the idea herein claimed may include any of a number of combinations of size, mounting, intensity, materials, batteries or plug-in power adapters which would accommodate, and be adaptable to fit, a wide range of portable or fixed telecommunications appliances currently in existence, or yet to be invented.

### BRIEF DESCRIPTION OF THE SEVERAL VIEWS OF THE DRAWINGS

The drawings referenced below represent several possible executions of this concept, with instructions for its manufacture later in this document. Specific materials of construction, intensity of lamps, mounting methods, battery pack design or AC adapter connection are not included in the drawings or descriptions as these may be adjusted or modified to address variations in computing or telecommunications appliance; or ultimate use of the invention.

FIG. 1 is a perspective drawing showing the front of an embodiment of the present invention. Referring now to the embodiment of the invention in more detail, FIG. 1 shows the device (10), consisting of four sections of equal length (a). Each section is made of plastic, aluminum or some such material sturdy enough to clip to the sides and top of a computer screen. Each section (a) contains an LED strip, all of equal length (not visible), each LED section containing the same number of LEDs. These may be single LED strips, for a simple white light, or strips made up of multiple colored LEDs, allowing for adjustment of color temperature. The front of each section (a) consists of a translucent panel, in this drawing covering the entire front surface, which diffuses the light from the LED strip behind it. Two sections are hinged at the corner (b) such that the device can clip onto the corners of a computer monitor. The two corners are connected by a cable (c) which, in this example, uses a spring mechanism to maintain tension between the two corner sections, and which provides electrical current between the two corner sections. The corner section (a) on the left side of the drawing has an electrical cable (d) which powers the four light strips. This electrical cable (d) is shown with a quick disconnect (e) which is, in turn, connected to a section of cable which contains (f) a battery pack sufficient to power the LEDs and terminating in a USB connection (g) permitting the batteries to be recharged either by the computer or by connecting the unit to a wall outlet or other power source via an adapter (not shown).

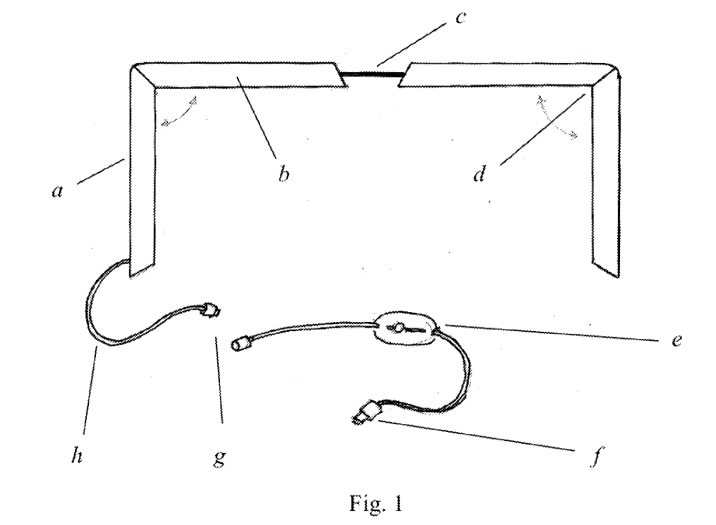

FIG. 2 is a perspective drawing showing the front of an embodiment of the the present invention such that it is collapsible and may be carried in a pocket or small container in its collapsed, or folded, state. The drawing shows a version of the invention (10) with the four individual sections containing LEDs (a) hinged at each corner (b) and exposing the connecting wires (i) where sections meet. This drawing also shows the tension cable (c) where it connects the two corner sections. Quick disconnect power cable (d) can be seen extending from the left side of the device (10). This drawing also shows a smaller diffusion panel (h) as an insert in each section (a). Such a panel would be made of plastic or glass and act to diffuse the light produced by the LEDs.

FIG. 3 is a perspective drawing of an embodiment of the present invention (10) connected to a laptop computer (k) in such a manner that the sections containing the lamps, in this example LEDs,(a) fit on the top left and right of the computer (k) display maintaining the built-in camera's (j) clear field of vision.

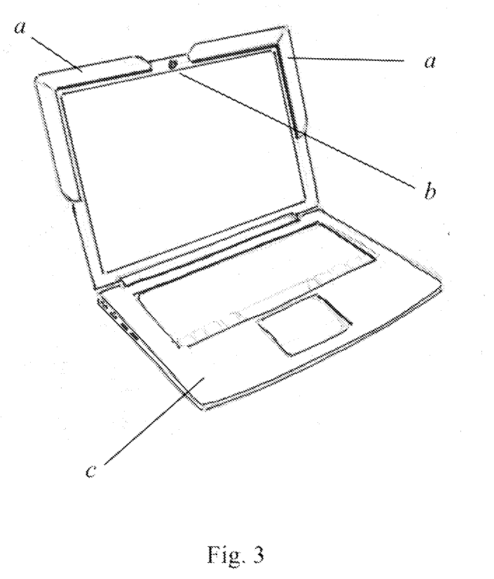

FIG. 4 is a perspective drawing of an embodiment of the present invention (10) connected to a desktop computer monitor (l). The sections (a) fit across the top and down the sides of the monitor (l) in the manner of a make-up mirror, leaving a gap across the top to accommodate the built-in web-camera (j).

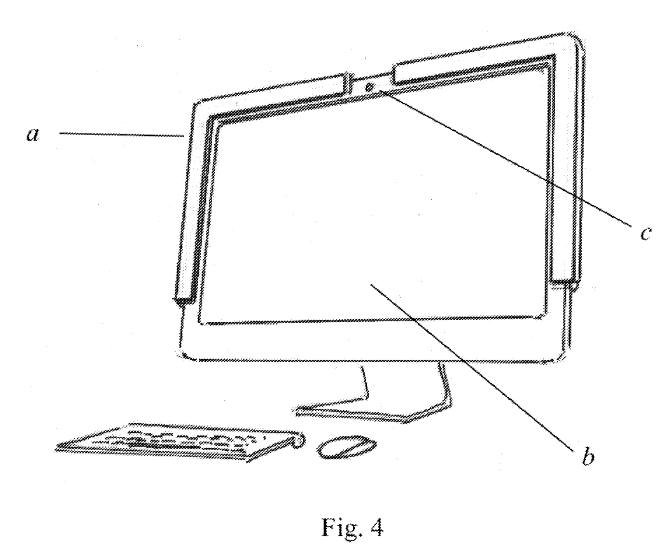

FIG. 5 is a perspective drawing of an embodiment of the present invention (20) configured to fit on a tablet computer (m). In this version of the invention, the tablet (m) is encased by the lighting system (20) which acts like a protective cover in addition to providing illumination. This variant could include LED panels on both sides of the casing to facilitate the use of forward and rearward facing cameras in the event the tablet is to be used, for example, to conduct an interview. The casing may be constructed of any appropriate material including exotic materials such as aluminum, leather or wood.

FIG. 6 is a perspective drawing of an embodiment of the present invention (10) showing a cross section view of a lighting section (a) in order to illustrate a spring hinged clip mechanism (n) which may be used to affix the section (a) to the computer display (not shown). The diffusion panel (h) is shown on the front of the section (a). The purpose of this drawing is to demonstrate one possible mounting method.

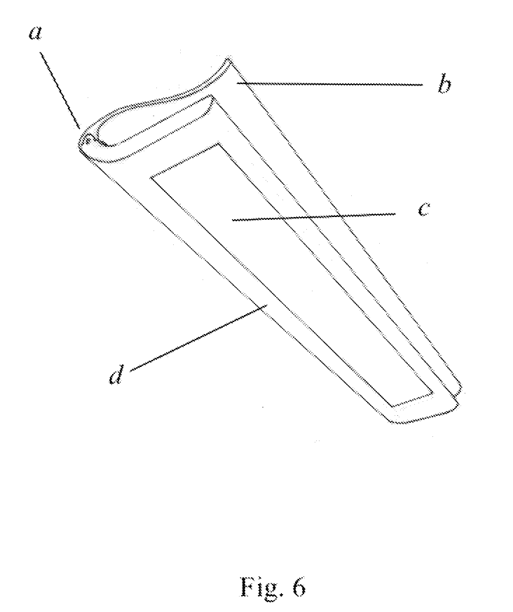

### DETAILED DESCRIPTION OF THE INVENTION

This lighting system device is designed to provide even illumination of a person or subject using a video screen on a computer, phone, tablet or other electronic device, especially in conjunction with a built in or attachable camera of the type commonly referred to as a “web-cam”. This constitutes the best mode of operation of this invention.

As stated previously in this document, Conventional lighting systems are usually built as stand-alone lamps, or as attachments to cameras, in the case of photographic lighting systems, or as clip on lamps intended to illuminate a work area, in the manner of a book or reading lamp. Video bloggers, news correspondents, people using the computer to record video journals or video conference currently have to use large, expensive photographic lighting devices, or modify existing household lighting devices in order to properly light their face or photo subject. It is not uncommon for users to be dark or barely visible if background light sources are too strong, such as bright sunlight, or too dim, as in the case of a dimly lit room. Use of lighting devices not intended for the purposes outlined above, can result in too much light on the subject, producing a “washed out” effect. Also, professional photographic lamps are large, expensive and difficult to carry from one location to another. The invention claimed here solves this problem.

Originally conceived for use by war correspondents embedded with troops or in the field, with nothing but a laptop or tablet computer with which to file their story, it became evident immediately that the lighting system herein claimed could be used by any individual requiring this type of illumination. Some examples are: video bloggers, independent journalists, individuals conducting a video conference or video based telecommunications, e.g. using the service known as “Skype” or some other video-phone or video based communication. The lighting system can be used for still portrait or live action photography. It may also be used to provide illumination for items like a still photo, text, picture or any number of small objects that can be captured with the built-in video camera (or similar web camera) on a computer, phone, tablet or other electronic device.

The claimed invention differs from, and improves upon, what currently exists. Unlike any current commercially available lighting system, this invention is designed to illuminate the user's face in the manner of a theatrical make-up mirror in order to improve the lighting on the subject when using web cameras that are built-in or attached to a computer display or tablet.

One critical new feature of this invention is that it connects directly to the desired appliance without requiring additional desk or tabletop surface area. Another critical feature of this invention is that it provides even illumination over the entire subject area. Another critical new feature of this invention is that it is portable. Another critical feature of this invention is that it is inexpensive.

### Description of Example or Preferred Embodiment

The present invention consists of lighting strips, in this case and preferably LED's, encased in a rigid frame with a translucent covering, lens or modifier, which can be attached to a computer screen or tablet computer so as to provide illumination on a subject without obstructing the view of a built-in or attached camera.

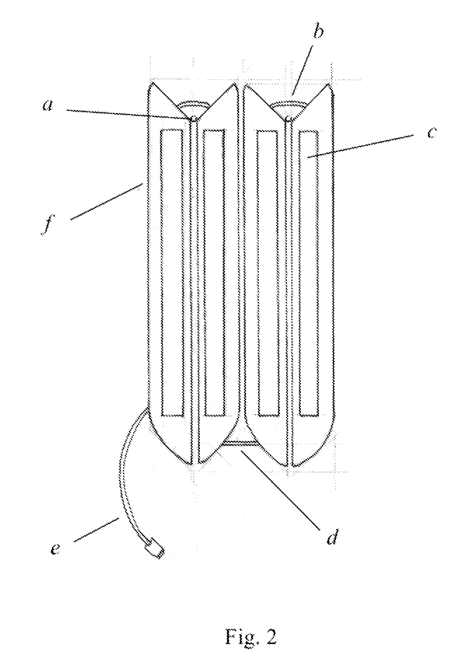

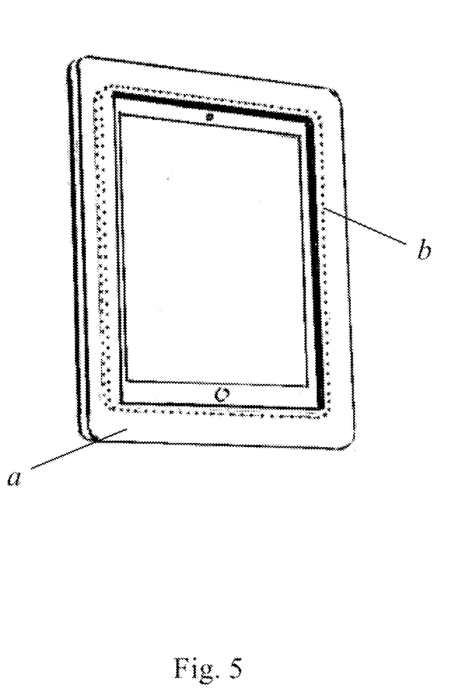

Two sets of sections (a) are each hinged at the corners (b) in order to allow them to fit on the top left and right corners of the computer display (l). The device is powered by batteries (e) and may be plugged into a wall outlet. Tablet versions may be in the form of a protective cover which encases the entire tablet computer, exposing its screen (FIG. 5). The device may be built to fold and collapse into a portable unit (FIG. 2), or may be constructed with a rigid frame, even including a built-in web camera of its own, for those screens not so equipped, or for repositioning of the camera in the case of some tablet computers.

### How the Invention Works

LED lighting strips are available for purchase by the foot and come in a wide variety of configurations ranging from simple single LED strips to multiple chip RGB LEDs that can change the color of the light. For the purposes of this embodiment of the invention, four equal length LED strips are placed into casings which can be attached to a computer screen and which have a translucent facing, cover or modifier which allows the light emitted from the LED's to pass through it and which diffuses, focuses or otherwise modifies the output of the LED's. The cases are arranged in pairs, each pair hinged in order to be affixed to the top left and right corners of a computer display screen, and the whole connected by electrical cable. The Power supply may be batteries or conventional wall outlet with a dimmer or control that allows the user to either dim the lamp or adjust its color or color temperature.

### How to Make the Invention

The present invention may be constructed of a wide range of materials. The essential components are as follows:

The lighting strips, currently available by the foot in a wide variety configurations. After selecting a light strip, measure and cut four sections. The length of the strips is determined by the size of the computer monitor (display or screen) and is computed by measuring the distance from the built in web camera to each corner. Cut four strips of equal length, unless a custom size is desired, and connect them together to form a circuit and allow connection to a power source.

The four light strips must now be connected to a power source which may be batteries, a wall outlet or any other source sufficient to illuminate the light strips.

A switch must also be installed in the circuit, in order to turn the lights on and off, which may also be a dimmer or which may control the color temperature of the light. The resulting lighting system must now be mounted in a rigid case, made of any suitable material which allows connection to the computer screen at each of the top corners. This casing needs to be constructed of four sections, paired into two corner units, such that each corner unit attaches securely to the computer screen at the top left and top right corners. The connected light strips must now be securely placed into the casings and covered with a diffusing lens of a material such as glass or plastic.

The essential elements are:
Light strips of some fashion, generally LED.
A method for connecting the light strips to the top and sides of the computer or smartphone.
A power source.

Additional elements could include dimmer switches, pulse modulators, color temperature controls or multiple power sources. Variations of the invention could be built to work with tablet computers such as the iPad. The invention could be made portable and collapsible, as in the first set of drawings, or rigid and permanent. The invention could be constructed of a wide range of materials which could be decorative or customized. One possible variation of the invention could include a built-in web camera. Another possible variation of the invention could be a large, professional quality housing with a built in high definition camera and large array of multiple LEDs into which one could place large display screens.

This invention can be reconfigured in a number of different ways to suit multiple needs and to fit multiple types of devices. The invention does not require the light source to be LED's. An “antique” effect could be achieved by constructing a large theatrical make up mirror in the dimensions of a computer display and simply replacing the mirror with the display. The invention could also be made very small, to fit hand held devices, or constructed as a case for a tablet computer, as in FIG. 5, which may also include a cover and which could be manufactured of exotic materials such as wood, leather or titanium.

### How to Use the Invention

Every day more and more people are recording their comments and opinions as video blogs. Many reporters and journalists record their articles for web use by reading into the built in camera on the computer. Corporations increasingly hold video conferences over computer networks. Skype and other forms of video telephony are also becoming more and more common. Many of these people look washed out, poorly lit and dim, despite the fact that web cameras have greatly increased in quality, simply because of poor lighting. The present invention completely solves that problem by providing exactly the correct kind of illumination required to light a human face under the above described conditions.

I claim:

1. A lighting device which attaches to a desktop, laptop or tablet computer or smartphone and provides even illumination of the user's face or other such subject as would be desirable to illuminate and which would be viewed, transmitted or recorded via a camera built into or attached to the aforementioned computer or smartphone in a manner similar to that of a theatrical make-up mirror.

2. The lighting device of claim 1 including a power source comprised of batteries. Said batteries may be standard issue AA batteries, for use in places where less common batteries would prove difficult or impossible to find, or more sophisticated rechargeable batteries, which may be more compact.

3. The lighting device of claim 1 with built-in camera for use with devices not so equipped.

4. The lighting device of claim 1 configured as a cover or protective case for tablet computers.

5. The lighting device of claim 4 configured with lighting panels facing both rearward (towards the user) and forward (towards a second subject) and which may further be equipped with handles on two or more sides in order to facilitate stability and provide ease of function.

6. The lighting device of claim 4 configured with a built-in camera.

7. The lighting device of claim 1 with a direct connection to wall outlets for powering the unit. This may be accomplished with an AC adapter, or the unit may be built using AC current.

8. The lighting device of claim 1 configured for smartphones and including a foldable or collapsible stand, in order to support said lighting device and the smartphone at a height suitable for video conferencing from a desk or table top.

9. The lighting device of claim 1 equipped with a rheostat or pulse modulator to dim the lamps.

10. The lighting device of claim 1 with hinged or telescoping top segments, allowing for adjustment of lighting direction.

11. The lighting device of claim 4 configured so as to include a computer display and camera as a part of its integral construction for use as a permanent fixture and in conjunction with externally connected computing devices and/or networks.
